(19) United States
(12) Patent Application Publication
(10) Pub. No.: US 2010/0156896 A1
(43) Pub. Date: Jun. 24, 2010

(54) METHOD OF CREATING THREE-DIMENSIONAL MODEL AND OBJECT RECOGNIZING DEVICE

(75) Inventors: Kengo ICHIMURA, Osaka (JP); Akira Ishida, Shizuoka (JP); Toyoo Iida, Nagaokakyo-shi (JP); Junichiro ueki, Nara-shi (JP); Kazuhiro Shono, Kyoto (JP); Yoshizo Togawa, Kyoto (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/619,911

(22) Filed: Nov. 17, 2009

(30) Foreign Application Priority Data
Nov. 18, 2008 (JP) P2008-294458

(51) Int. Cl. G06T 15/00; G06K 9/00

(52) U.S. Cl. 345/419; 382/154

(57) ABSTRACT

This invention aims to ensure accuracy of a three-dimensional model to be registered. With information a of three-dimensional information a, b, c restored by measuring an actual model of a work, which is a target of three-dimensional recognition, from different directions as a reference, other three-dimensional information b, c are coordinate transformed so as to be aligned with the reference three-dimensional information, and three-dimensional information d including all of three-dimensional information b′, c′ after the transformation and the reference three-dimensional information a is created. The three-dimensional information d is temporarily registered as the three-dimensional model. A difference amount among the integrated three-dimensional information a, b′, c′ is calculated, and an evaluation index based on the difference value is displayed with an image view of a contour pattern represented by the three-dimensional model. A user checks the accuracy of the three-dimensional model on this display screen from a degree of variation of the contour line representing the same site and a value of the evaluation index, and determines whether or not to actually register the three-dimensional model d.

### BACKGROUND OF THE INVENTION

This application is based on Japanese Patent Application No. 2008-294458 filed with the Japan Patent Office on Nov. 18, 2008, the entire content of which is hereby incorporated by reference.

1. Technical Field

The present invention relates to a method of creating a three-dimensional model of an object to perform a process of recognizing the position and the orientation of the object using three-dimensional information restored by stereo measurement using a plurality of cameras with an object having a predetermined shape as a target. The present invention also relates to a device for performing, after creating and registering the three-dimensional model, a recognition process of the object using the model.

2. Related Art

A three-dimensional model containing three-dimensional information of various surfaces of an object to be recognized needs to be created to recognize the position and the orientation of the object by a three-dimensional recognition process using a stereo camera.

Japanese Patent Publication No. 2961264 (see paragraphs 0013, 0017, 0028 to 0036) discloses the invention having the above problems. Japanese Patent Publication No. 2961264 describes creating a geometric model of the entire object by performing the stereo measurement from a plurality of directions with respect to an actual model of a target object to be recognized and aligning and integrating three-dimensional information restored by each measurement.

Japanese Patent Publication No. 2961264 also describes restoring three-dimensional information of a contour line of the actual model from an edge shown in the stereo image through a method called “segment based stereo”. According to Japanese Patent Publication No. 2961264, the “segment based stereo” is a process of dividing the edge in the stereo image into units called a “segment”, and performing a stereo correspondence search in units of segments to restore the three-dimensional information of the contour line.

Furthermore, Japanese Patent Publication No. 2961264 describes a method of rotating an actual model to a defined angle using a rotary table and performing a coordinate transformation based on the rotational angle with respect to alignment of the three-dimensional information. As a method of aligning the three-dimensional information from an unknown observation direction, obtaining candidates of a plurality of alignments by matching the model being created and the newly restored three-dimensional contour line, and specifying the alignment when a coincidence degree becomes the highest are also described.

“Stereo Correspondence Using Segment Connectivity” Information Processing Society of Japan, Vol. 40, No. 8, pp. 3219-3229, published August 1999 describes in detail a method of corresponding the two-dimensional segment between images, and restoring the three-dimensional information. “Three-Dimensional Object Recognition Using Stereo Vision” IEICE Transactions, D-11, vol. J80-D-II, No. 5, pp. 1105-1112, published May 1997 discloses a method of matching the restored three-dimensional information with the three-dimensional model registered in advance, and recognizing the position and the orientation of the object.

### SUMMARY

The invention described in Japanese Patent Publication No. 2961264 creates a three-dimensional model in which three-dimensional characteristics of an object seen from various directions are integrated, and thus a three-dimensional model suited for recognizing an object which position and orientation are not fixed, such as discretely stacked parts, can be created. However, if the three-dimensional model is created using the “method of aligning the three-dimensional information from an unknown observation direction” of Japanese Patent Publication No. 2961264, accuracy of the three-dimensional model is difficult to ensure for the following reasons.

The “method of aligning the three-dimensional information from an unknown observation direction” specifically calculates a coincidence degree by arbitrarily changing a positional relationship between an actual model and a stereo camera and corresponding the three-dimensional information restored through respective measurements between two executed stereo measurements in plural manners, and performs alignment using the correspondence relationship of when the coincidence degree is the highest. Therefore, if the correspondence between the three-dimensional information is not performed with satisfactory accuracy, the accuracy of the alignment cannot be ensured and the final three-dimensional model will not have a satisfactory accuracy.

First, if a chamfered portion or a curved surface is a measurement target, error in correspondence due to the cause shown in FIG. 14 may occur.

FIG. 14 shows an example of performing stereo measurement from two directions f1 and f2 with respect to a corner of a target object to be recognized Sb. This figure is a cross-section of the target object to be recognized Sb, where R1 and R2 in the figure correspond to boundary positions of a flat surface and a surface with large curvature.

In this example, the three-dimensional edge is restored at the position of R1 in the figure in the measurement from the f1 direction, whereas the three-dimensional edge is restored at the position of R2 in the measurement from the f2 direction. Therefore, when corresponding the three-dimensional information restored by the measurement from the respective directions, the edge corresponding to R1 and the edge corresponding to R2 may be falsely corresponded and the accuracy in alignment may degrade accordingly.

FIG. 15 shows an example in which an error occurred in correspondence of sites including a repetitive structure. Such false correspondence may occur when the edge of the repetitive structure is unclear and the restoring accuracy of the three-dimensional information is degraded.

Even when having an object with a symmetrical site as a recognizing target, a state where the front and the back of the symmetrical site are falsely corresponded may be recognized as correct.

Many industrial products and molded articles include chamfered portions or curved surfaces, and many repetitive structures and symmetrical sites are also recognized. Therefore, when creating a three-dimensional model related to such objects, a false alignment is performed due to the above reason, where if pieces of the three-dimensional information after the alignment are integrated, the accuracy of the three-dimensional model created by such integration degrades, and the recognition process may also be affected.

The present invention has been devised to solve the problems described above, and an object thereof is to ensure the accuracy of the three-dimensional model to be registered when registering the information in which a plurality of pieces of three-dimensional information respectively representing the different orientations of the actual model are integrated as a three-dimensional model.

A method of creating a three-dimensional model of the present invention executes a process of restoring three-dimensional information of a contour line through three-dimensional measurement using a stereo camera with respect to an actual model of a target object to be recognized while arbitrarily changing a positional relationship between the actual model and the stereo camera every time. The method then aligns the three-dimensional information restored by the measurement of a plurality of times, and integrates each piece of the three-dimensional information after the alignment to create a three-dimensional model of the target object to be recognized.

In the above description, the three-dimensional information restored by the three-dimensional measurement is a collection of a plurality of pieces of three-dimensional feature data representing a three-dimensional shape of the contour line of the actual model. The alignment of the three-dimensional information is the process of performing coordinate transforming on each piece of the three-dimensional information based on the respective correspondence relationship.

In the specific example described above, the information having the configuration of encompassing all pieces of the aligned three-dimensional information is created for the process of integrating the three-dimensional information after the alignment, but the present invention is not limited thereto. For example, the coordinate configuring the relevant contour pattern is used as is for the contour pattern that appears only in one piece of the three-dimensional information, whereas one of the contour patterns is selected for the contour pattern that appears in an overlapping manner among a plurality of pieces of three-dimensional information. Alternatively, the coordinates in a correspondence relationship between the overlapped contour patterns may be combined to obtain a coordinate of a representative point such as an average value of each coordinate for every combination, and the coordinate of the representative point obtained for every combination may be incorporated in integrated information.

As described above, when creating the three-dimensional model through the method of aligning and integrating two or more pieces of three-dimensional information restored by the three-dimensional measurement from different directions, the accuracy of the three-dimensional model changes depending on whether or not each piece of three-dimensional information is correctly aligned. In view of such an aspect, in the method according to the present invention, the step of mutually matching a plurality of pieces of three-dimensional information to be integrated to extract information in an overlapped relationship in each piece of three-dimensional information and calculating the difference amount between the contour patterns represented by each piece of extracted information, the step of determining an evaluation value representing accuracy of integrated information by the plurality of pieces of three-dimensional information based on the difference amount, and the step of outputting the determined evaluation value are executed before or after integrating the plurality of pieces of three-dimensional information.

In the above description, for example, the information extracted by matching the three-dimensional information is combined for every piece of information in an overlapped relationship, and the difference amount is calculated for every combination in the step of calculating the difference amount. In the step of determining the evaluation value, for example, the average value or the maximum value of the difference amount calculated for every combination, or the value in which such values are replaced with the numerical value indicating the accuracy of the three-dimensional model (numerical value representing the highness of the coincidence degree between the three-dimensional information) is determined as the evaluation value.

When the correspondence of the three-dimensional information to be integrated is correctly performed and each piece of three-dimensional information is aligned based on the result of such correspondence, the difference between the contour patterns by the information in an overlapped relationship is very small. On the other hand, when a false correspondence is performed between the three-dimensional information, the contour pattern by the information in an overlapped relationship varies even after the alignment, whereby the different amount becomes large. In the above described method, a specific numerical value reflecting the degree of variation of the contour pattern by the information in an overlapped relationship between the three-dimensional information to be integrated is outputted, and thus the user can determine whether or not to adopt the integrated information corresponding to the evaluation value as the three-dimensional model based on the outputted numerical value. Therefore, if the accuracy of the integrated information is not satisfactory by the evaluation value, measures such as changing the combination of the three-dimensional information to be integrated or again performing the measurement with the condition of the three-dimensional measurement changed can be taken, and the three-dimensional model having unsatisfactory accuracy can be prevented from being registered.

In a preferred aspect of the above method, the steps of accepting a determination input on whether or not to adopt the integrated information corresponding to the evaluation value as the three-dimensional model after the output of the evaluation value; and confirming the integrated information as the three-dimensional model in response to accepting the determination input to adopt the integrated information as the three-dimensional model are further executed.

According to the above aspect, when judged that the accuracy of the model is sufficient by the output evaluation value, the user makes a determination input to adopt the integrated information as the three-dimensional model to confirm the relevant integrated information as the three-dimensional model. If the evaluation value is outputted before integrating the three-dimensional information, the generated integrated information is confirmed as the three-dimensional model after executing the process of aligning and integrating the three-dimensional information to be integrated according to the determination input.

In another preferred aspect of the method, the step of generating an image reflecting all contour patterns by the three-dimensional information after the alignment is executed at least before the step of outputting the evaluation value (anteroposterior relation of the step of calculating the difference amount and the step of determining the evaluation value is irrelevant). The step of displaying the evaluation value with the image is executed as the step of outputting the evaluation value.

According to the above aspect, the user can check the degree of variation of the actual contour pattern from the image along with the evaluation value, and thus can more easily determine the accuracy of the integrated information.

In still another preferred aspect of the above method, in the three-dimensional measurement of every time on the actual model, the three-dimensional information having a configuration in which a three-dimensional coordinate representing a contour line is grouped to a plurality of three-dimensional segments is generated. In the step of calculating the difference amount in this case, the difference amount related to the combination is calculated for every combination of the three-dimensional segments in correspondence relationship between the three-dimensional information before integration. Alternatively, in the step of calculating the difference amount, an intersection between each three-dimensional segment is combined for every correspondence between the three-dimensional information before integration, and the difference amount related to the combination is calculated for every combination.

When calculating the difference amount for every corresponding site between the three-dimensional information, such a difference amount is desirably individually outputted or each difference amount is compared with a predetermined acceptable value to specify the site where the difference exceeding the acceptable value appeared, and the specified result is desirably outputted. The user then can analyze the relationship between each site and the difference amount in detail, and determine whether or not to adopt the candidate being displayed as the three-dimensional model. For example, when the difference amount exceeding the acceptable value is calculated, the determination result on whether or not to adopt the integrated information as the three-dimensional model can be divided depending on at which site the difference amount is generated or the number of sites where the difference amount exceeding the acceptable value is generated.

In yet another preferred aspect of the above method, in three-dimensional measurement of every time, with an actual model attached with a mark having a known geometric feature on the surface as a target, the positional relationship between the actual model and each camera is adjusted so that the mark is contained in fields of all cameras configuring the stereo camera. Moreover, in the step of calculating the difference amount, each piece of the three-dimensional information to be integrated is matched by a contour pattern of the mark based on the known geometric feature to extract the contour pattern of the mark, and the difference amount between the contour patterns extracted from each piece of the three-dimensional information is calculated.

In the above aspect, the three-dimensional information containing the contour pattern of the mark is always restored in the three-dimensional measurement, the candidate of the three-dimensional model is created by each piece of the restored three-dimensional information and then the difference amount between the contour patterns of the mark contained in the candidate is calculated. Thus, the evaluation value reflecting the degree of variation of all pieces of three-dimensional information can be obtained based on the overlapped information in all pieces of the three-dimensional information that are integrated.

In the above aspect, the integrated information not containing the information corresponding to the mark is desirably assumed as the three-dimensional model when determined to adopt the integrated information corresponding to the evaluation value as the three-dimensional model (if the integrated information is already generated, the information corresponding to the mark is erased or invalidated and the integrated information after such a process is registered). Since a mark is not given to the actual target object to be recognized, the recognition accuracy may lower if the three-dimensional model including the information of the mark is used.

An object recognizing device applied with the above method includes a three-dimensional measurement unit for restoring three-dimensional information of a contour line of a target object to be recognized through three-dimensional measurement using a stereo camera, a recognition processing unit for recognizing a position and an orientation of the target object to be recognized by matching the restored three-dimensional information with a three-dimensional model registered in advance, a three-dimensional model creating unit for aligning a plurality of pieces of three-dimensional information restored through the three-dimensional measurement executed by the three-dimensional measurement unit from different directions on an actual model of the target object to be recognized and creating a three-dimensional model to be used by the recognition processing unit by integrating each piece of the three-dimensional information after the alignment, and a three-dimensional model registering unit for registering the created three-dimensional model. Furthermore, the three-dimensional model creating unit includes a difference amount calculating portion, an evaluation value determining portion, and an output portion described below.

The difference amount calculating portion extracts information in an overlapped relationship in each piece of three-dimensional information by matching a plurality of pieces of three-dimensional information to be integrated with each other and calculates a difference amount between contour patterns represented by the extracted information. The evaluation value determining portion determines an evaluation value representing accuracy of the integrated information including the plurality of pieces of three-dimensional information based on the calculated difference amount, and the output portion outputs the evaluation value determined by the evaluation value determining portion.

According to the device of the above configuration, when creating the three-dimensional model using the three-dimensional information restored by the three-dimensional measurement of a plurality of times with respect to the actual model of the target object to be recognized, the accuracy of the integrated information by each pieces of three-dimensional information is checked, and then registered as the three-dimensional model. Thus, the recognition process of satisfactory accuracy can be carried out by the registered three-dimensional model.

In one aspect of the object recognizing device described above, the three-dimensional model creating unit further includes, an input portion for accepting a determination input on whether or not to adopt the integrated information corresponding to the evaluation value as the three-dimensional model after the output of the evaluation value, and a model confirming portion for confirming the integrated information as the three-dimensional model when the input portion accepts the determination input to adopt the integrated information as the three-dimensional model.

In another preferred aspect, the three-dimensional model creating unit further includes an image generating portion for generating an image reflecting all contour patterns by each piece of the three-dimensional information after the alignment. In addition, the output portion is configured as a portion for displaying the evaluation value along with the image generated by the image generating portion.

In still another preferred aspect, a registering unit for registering a contour pattern based on a geometric feature for a mark created on a premise of being attached to a surface of the actual model. In addition, the difference amount calculating portion extracts the contour pattern of the mark by matching the three-dimensional information to be integrated by the contour pattern registered in the registering unit, and calculates the difference amount between the contour patterns extracted from each piece of the three-dimensional information.

According to the above aspect, with the actual work attached with the registered mark as the target, the positional relationship with the stereo camera is changed every time and the three-dimensional measurement over a plurality of times is executed, so that the candidate of the three-dimensional model by the three-dimensional information restored by each measurement is created, and registration can be carried out after checking the accuracy of the candidate based on the difference amount of the contour pattern of the mark.

According to the present invention, when creating the three-dimensional model through the method of aligning and integrating a plurality of pieces of three-dimensional information restored by the three-dimensional measurement on the actual model based on the correspondence relationship, the evaluation value representing accuracy of integrated information by each piece of the three-dimensional information is outputted, and thus the three-dimensional model having unsatisfactory accuracy due to false correspondence among the three-dimensional information is prevented from being created and registered as is. Therefore, the accuracy of the three-dimensional model to be registered can be ensured and the three-dimensional recognition process can be stably performed.

### BRIEF DESCRIPTION OF THE DRAWINGS

FIG. 1 is a view showing a schematic configuration of a picking system applied with a three-dimensional recognition process;

FIG. 2 is a block diagram of an object recognizing device;

FIG. 3 is a flowchart showing a procedure of the three-dimensional recognition process;

FIGS. 4A and 4B are views showing a measurement method of a work model;

FIG. 5 is a view showing a schematic procedure of a process of creating a three-dimensional model;

FIGS. 6A and 6B are views showing examples of a screen for checking the three-dimensional model;

FIG. 7 is a flowchart showing a procedure of a process of creating an evaluation index;

FIG. 8 is a flowchart showing a procedure related to creating and registering the three-dimensional model;

FIGS. 9A and 9B are views showing an example of measuring a work model attached with a mark;

FIG. 10 is a view showing a schematic procedure of when creating the three-dimensional model from the three-dimensional information of the work model attached with the mark;

FIG. 11 is a view showing a characteristic of a triangle represented by the mark;

FIG. 12A is a view showing a plurality of correspondence states of each vertex of the triangle and FIG. 12B is a graph showing a coincidence degree;

FIG. 13 is a view showing another example of a screen for checking the three-dimensional model;

FIG. 14 is a view describing a cause an error that occurs in the correspondence of the three-dimensional information; and

FIG. 15 is a view describing another cause an error that occurs in the correspondence of the three-dimensional information.

### DETAILED DESCRIPTION

(1) Device Configuration

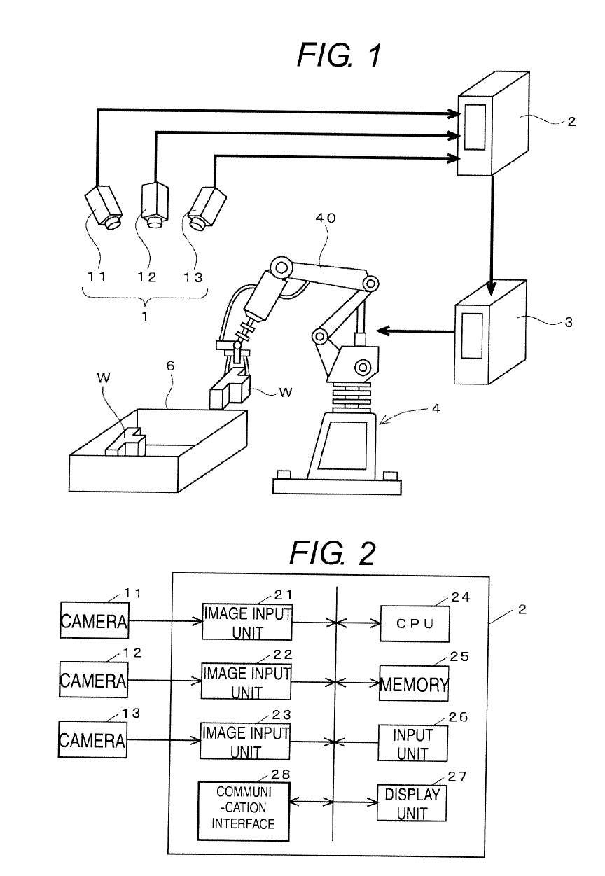

FIG. 1 shows an example of a picking system applied with a three-dimensional recognition process. The picking system performs a task of taking out a work W accommodated in an accommodation box 6 one at a time and conveying the work W to a predetermined position in a factory, and includes an articulated robot 4 that performs the actual task and a robot control device 3 for controlling the operation of the robot 4. The picking system also includes a stereo camera 1 and an object recognizing device 2 for recognizing the position and the orientation of the work W to be processed.

The stereo camera 1 is configured by three cameras 11, 12, 13 which positional relationship is fixed. The object recognizing device 2 is registered with information representing the positional relationship of the cameras 11, 12, 13, a direction of an optical axis, and the like, as well as a three-dimensional model of the work W to be recognized, and processes a stereo image inputted from each camera 11, 12, 13 to restore the three-dimensional information of the contour line of the work W, and then matches the restored three-dimensional information and the three-dimensional model to recognize the position and the orientation of the work W. The information indicating the recognition result is outputted from the object recognizing device 2 to the robot control device 3, and is used in the process of controlling an operation of an arm 40 of the robot 4 in the robot control device 3.

FIG. 2 shows a hardware configuration of the object recognizing device 2.

This device includes, in addition to image input units 21, 22, 23 corresponding to each camera 11, 12, 13, a CPU 24, a memory 25, an input unit 26, a display unit 27, a communication interface 28, and the like. The input unit 26 is a keyboard, a mouse, or the like for inputting information by an operation of a user, and the display unit 27 is a liquid crystal monitor. The input unit 26 and the display unit 27 are used in applications where the user checks the imaging state of the actual model or performs a selecting operation or a setting operation when creating the three-dimensional model described below. The communication interface 28 is used to communicate with the robot control device 4.

The memory 25 includes a large capacity memory such as a ROM, RAM, and hard disk.

The CPU 24 executes a series of processes related to the three-dimensional measurement and the recognition of the work W based on a program stored in the memory 25, where the recognition result (specifically, three-dimensional coordinate representing the position of the work W, and rotation angle with respect to the three-dimensional model) is outputted by the communication interface 28.

The memory 25 also stores a program for creating the three-dimensional model. Prior to the recognition process, the CPU 24 creates the three-dimensional model of the work W using the image of the actual model inputted from each camera 11 to 13 based on the relevant program, and registers the same in the memory 25.

Although not shown in FIG. 2, the object recognizing device 2 of the embodiment also includes a circuit for outputting a drive signal to each camera 11, 12, 13, where the CPU 24 is set with a function of controlling the imaging operation of each camera 11 to 13 through this circuit.

(2) Regarding Three-Dimensional Recognition Process

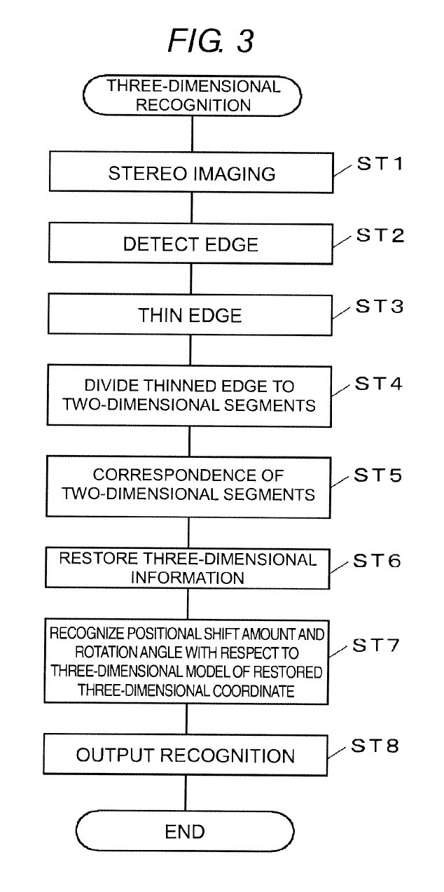

In the object recognizing device 2 described above, the three-dimensional information is restored for every unit called a “segment” and matching is performed with the three-dimensional model in units of segments after detecting an edge from the stereo image, similar to the invention described in Japanese Patent Publication No. 2961264. FIG. 3 shows a schematic procedure of a process executed to recognize one work through such a method. The three-dimensional recognition process in the present embodiment will be described below with reference to the step numbers of FIG. 3.

First, the stereo imaging by each camera 11 to 13 is performed, and an edge extraction filter is applied on each generated image to detect the edge in the image (ST1, 2). The detected edge is then thinned (data having width of one pixel), and the thinned edge is divided into segments of a line or a curve with a connecting point or a branched point as a reference (ST3, 4). The segment extracted from the edge of the two-dimensional image is hereinafter referred to as the “two-dimensional segment”.

A process of corresponding the two-dimensional segments in correspondence relationship between images is then executed (ST5). In such correspondence, with one of the three images as a reference, each two-dimensional segment of the reference image is focused in order, and the corresponding two-dimensional segment is specified from the other two images for every focused two-dimensional segment. In other words, with respect to the focused two-dimensional segment, the two-dimensional segment which satisfies an epipolar condition and which connecting relationship with a nearby segment is aligned is detected from each image (see “Correspondence evaluation based on connecting property in segment based stereo” Information Processing Society of Japan, Vol. 40, No. 8, pp. 3219-3229, published August 1999 and the like for details).

Then, a process of restoring the three-dimensional information from the correspondence relationship for every combination of the two-dimensional segment corresponded by the above-described process is executed (ST6).

Briefly describing, a three-dimensional coordinate of a certain pixel in the correspondence relationship between the segments is calculated for every combination of the corresponded two-dimensional segments. The distribution state of the calculated three-dimensional coordinate is matched with a linear and an arcuate model to determine whether the collection of three-dimensional coordinates corresponds to line/curve. According to such a process, the three-dimensional segment of a line or a curve that corresponds to the combination is specified for every combination of the two-dimensional segments.

Furthermore, in ST6, with respect to each three-dimensional segment, the respective segment is sampled for every interval set in advance to create information in which a type of segment (line or curve) and a three-dimensional coordinate of each sampling point are corresponded. Thus, more three-dimensional coordinates than the beginning can be obtained by making the sampling interval smaller even with respect to the three-dimensional segment in which the number of three-dimensional coordinates calculated from the two-dimensional segment is few.

The collection of three-dimensional segments restored through the above-described process corresponds to the three-dimensional information of the work to be recognized. In the next stage, the three-dimensional model is set at a predefined reference position of the three-dimensional coordinate system, and such a three-dimensional model and the restored three-dimensional information are matched to recognize the positional shift amount and the rotation angle of the work with respect to the three-dimensional model (ST7).

In the matching process of ST7, the coincidence degree of each three-dimensional segment of when correspondence is performed is calculated while corresponding each feature point in a best subset selection procedure with the intersection of each three-dimensional segment as a feature point, and the correspondence of when the coincidence degree is a maximum is specified as a correct correspondence relationship.

ST7 will be more specifically described. In the present embodiment, each feature point of the three-dimensional information to be matched is corresponded in order to one feature point on the three-dimensional model side, and the shift amount and the rotation angle necessary for moving the feature point on the three-dimensional model side to the correspondence point are calculated for every correspondence. The shift amount and the rotation angle are calculated for every axis of X, Y, and Z. All coordinates contained in the three-dimensional model are then transformed based on the calculated shift amount and the rotation angle, and the coincidence degree of the three-dimensional model after the transformation and the three-dimensional information to be matched is calculated.

In the calculation of the coincidence degree, the coincidence degree with respect to the three-dimensional model is obtained (hereinafter referred to as “coincidence degree in units of segments”) for each three-dimensional segment contained in the three-dimensional information to be matched, and the sum, the average value, and the like of the coincidence degree in units of segments are assumed as the entire coincidence degree. In the calculation process of the coincidence degree in units of segments, the three-dimensional segment at a closest position on the three-dimensional model side is specified for the three-dimensional segment to be matched, and the coincidence degree with such a segment is calculated. If the three-dimensional segment to be calculated does not exist within a predetermined distance from the three-dimensional segment to be matched, the coincidence degree is zero. If a plurality of three-dimensional segments exists with substantially the same distance, the highest coincidence degree of the coincidence degrees thereto is adopted.

As described above, the coordinate transformation of the three-dimensional model and the calculation process of the coincidence degree are executed with the feature point on the three-dimensional model side and the feature point of the three-dimensional information to be matched corresponded in the best subset selection procedure. The shift amount and the rotation angle used in the coordinate transformation of when the highest coincidence degree is obtained are ultimately recognized as the positional shift amount and the rotation angle with respect to the three-dimensional model of the work W to be recognized.

Thereafter, the recognized positional shift amount and the rotation angle are outputted to the robot control device 3 (ST8), and the process is terminated.

(3) Process of Creating Three-Dimensional Model

### 3-1) First Embodiment

To execute the three-dimensional recognition process described above, the three-dimensional model of the work W needs to be registered in the memory 25 in advance. In the object recognizing device of this embodiment, the three-dimensional model is created through a method of stereo measuring the actual model of the work W from various directions and integrating the three-dimensional information restored from each measurement result. This process will be described in detail below.

In the following figures, the actual model of the work W is denoted with a reference numeral WM, and the actual model WM is referred to as “work model WM” herein.

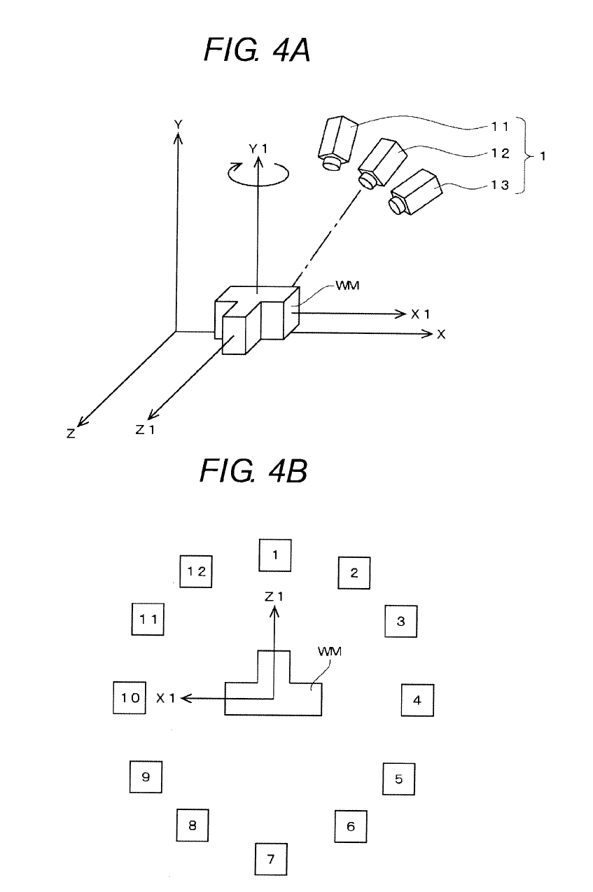

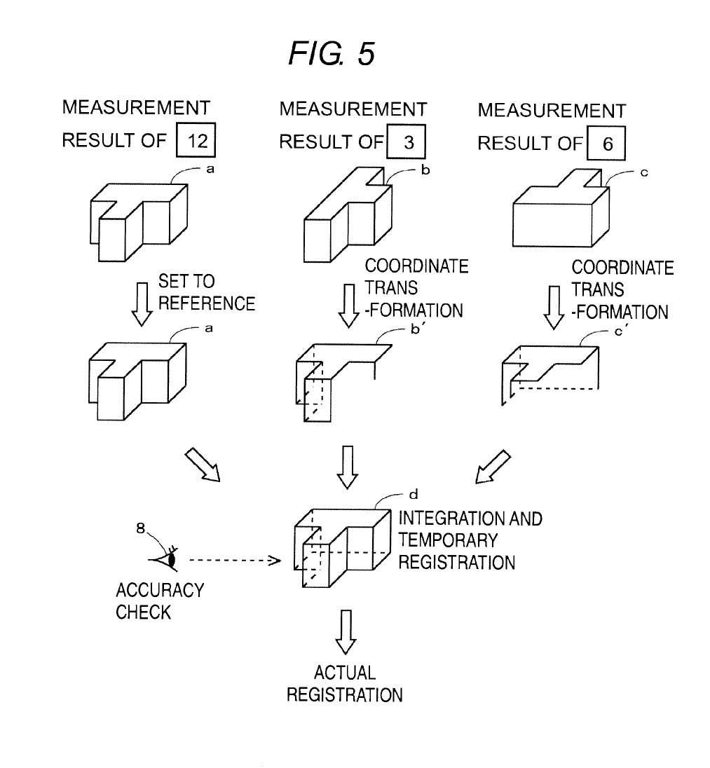

In the first embodiment, as shown in FIG. 4A, the stereo measurement of a plurality of times is executed while changing the orientation of the work model WM with respect to the stereo camera 1 with the position and the optical axis direction of the stereo camera 1 fixed. A predetermined number (two or more) of pieces of three-dimensional information is selected from the three-dimensional information restored by each measurement, and then integrated to create the three-dimensional model of the work W.

The three-dimensional coordinate system including each axis of X, Y, and Z in the figure is a coordinate system for calculation of the three-dimensional coordinate (hereinafter referred to as “measurement coordinate system”), and is uniquely defined with respect to the stereo camera 1. The three-dimensional coordinate system including each axis of X1, Y1, and Z1 is a coordinate system (hereinafter referred to as “work coordinate system”) uniquely defined with respect to the work model WM. In FIG. 4A, each axis of X1, Y1 and Z1 is shown in a state parallel to the X, Y, and Z axes, but the direction of each axis of the work coordinate system accordingly changes when the orientation of the work model WM changes.

The orientation of the work model WM can be freely defined by the user, but in this embodiment, assuming a specific surface constantly lying along the X1Z1 plane is in contact with the work supporting surface (XZ plane in this example), the work model WM is rotated once with respect to the Y1 axis orthogonal to the XZ plane, and the imaging of a plurality of times is performed meanwhile. The rotation of the work model WM is performed through a method of changing the direction of the work model WM with the hand of the user without using the rotary table, and thus not only the rotation angle but the position of the work model WM with respect to the measurement coordinate system also shifts every time.

FIG. 4B shows a change in the positional relationship of the stereo camera 1 with respect to the work model WM with the work coordinate system as the reference. In the figure, rectangles with numbers 1 to 12 each indicate the location of the stereo camera 1 during imaging, and the numbers in the rectangle indicate the order of imaging.

The stereo images generated by imaging at such positions are all targets of three-dimensional measurement. Thus, the position of the stereo camera represented by each rectangle is hereinafter referred to as “measurement point”. When referring to each measurement point, the numbers representing the order of measurement such as “measurement point [1]” and “measurement point [2]” are cited.

In this embodiment, the processes similar to ST1 to ST6 of FIG. 3 are executed to restore the three-dimensional information for every 12 measurement points. At each measurement point excluding the measurement point [1], the three-dimensional information restored at the respective measurement points is matched with the three-dimensional information of the measurement point one before to recognize the positional shift amount and the rotation angle with respect to the three-dimensional information of one stage before. Such recognition process is performed through a method similar to the method performed in ST7 of FIG. 3.

With respect to the last measurement point [12], the positional shift amount and the rotation angle with respect to the three-dimensional information of the measurement point [1] are obtained in addition to the positional shift amount and the rotation angle with respect to the three-dimensional information of the measurement point [11]. Alternatively, the process may again proceed to the measurement point [1] from the measurement point [12] to re-execute the measurement, and the positional shift amount and the rotation angle with respect to the three-dimensional information of the measurement point [12] of the restored three-dimensional information may be obtained.

FIG. 5 schematically shows a processing procedure of when creating the three-dimensional model using three pieces (indicated as a, b, and c in the figure) of the three-dimensional information restored at 12 measurement points for the work model WM. Three-dimensional information a in the figure is restored at the measurement point [12] in FIG. 4B. T-dimensional information b is restored at the measurement point [3], and three-dimensional information c is restored at the measurement point [6].

In this example, with the three-dimensional information a as a reference, the other three-dimensional information b, c are coordinate transformed so as to resolve the positional shift and the angular shift with respect to the reference three-dimensional information a. Three-dimensional information d containing the features of the respective information is created by integrating the three-dimensional information b′, c′ after the transformation and the reference three-dimensional information a. Furthermore, the accuracy as the three-dimensional model can be checked through the method of temporarily registering the three-dimensional information d as the three-dimensional model of the work W, and thereafter checking the image view (referring to the image representing the three-dimensional shape of the contour) and the like of the temporary three-dimensional model with the eye 8 of the user. The three-dimensional information d is actually registered when sufficient accuracy is recognized.

The coordinate transformation process of the three-dimensional information is performed using the positional shift amount and the rotation angle previously obtained for every measurement point. For example, in order to align the three-dimensional information b restored at the measurement point [3] to the three-dimensional information a restored at the measurement point [12], the coordinate transformation is performed using the positional shift amount and the rotation angle obtained for each combination of the measurement points [3] and [2], the measurement points [2] and [1], and the measurement points [1] and [12]. Similarly for the three-dimensional information c restored at the measurement point [6], the alignment to the three-dimensional information a is performed by executing the coordinate transformation using the positional shift amount and the rotation angle calculated in a range from the measurement point [6] to the measurement point [12] (in this case, either clockwise direction/counterclockwise direction).

As described above, when obtaining the positional shift amount and the rotation angle between the measurement points with a spacing, each measurement point in between is combined for every adjacent points to calculate the positional shift amount and the rotation angle of the three-dimensional information for every set of measurement points because matching the information containing common features as much as possible allows the accuracy of matching to be ensured. However, if assumed that sufficient accuracy can be obtained with the method of directly matching the three-dimensional information to be integrated, the positional shift amount and the rotation angle of other three-dimensional information b, c with respect to the reference three-dimensional information a may be obtained through direct matching.

A process of checking the accuracy of the three-dimensional information d set as a temporary three-dimensional model will now be described.

In this embodiment, the three-dimensional information a, b′, c′ to be integrated are all contained in the temporary three-dimensional model d. Therefore, with respect to a predetermined site of the work model WM, if the three-dimensional segment representing the relevant site is contained in two or more pieces of the three-dimensional information a, b′, c′ of before the integration, the temporary three-dimensional model d takes over all such three-dimensional segments.

As described above, in the matching process (ST7 of FIG. 3) with the three-dimensional model, one corresponding three-dimensional segment is specified from the three-dimensional model side with respect to the three-dimensional segment to be matched, and the coincidence degree is obtained. Therefore, even if the corresponding three-dimensional segment exists in plurals on the three-dimensional model side with respect to one of the three-dimensional segments to be matched, significant trouble does not arise even if any three-dimensional segment is corresponded when the difference amount between the three-dimensional segments is small.

When the three-dimensional segment representing the same site is contained in a plurality of pieces of three-dimensional information, if each piece of three-dimensional information is correctly corresponded and the aligned, the difference amount barely exists among the three-dimensional segments or only the difference amount of a tolerable range exists. In other words, since the state in which the difference amount among the three-dimensional segments representing the same site is small means that integrated three-dimensional information are correctly aligned, the accuracy of other non-overlapping three-dimensional segment is also assumed to be guaranteed.

If the difference amount among the plurality of three-dimensional segments representing the same site exceeds a tolerable range, this means that the integrated three-dimensional information are not correctly aligned, and thus the accuracy of other non-overlapping three-dimensional segment also cannot be guaranteed.

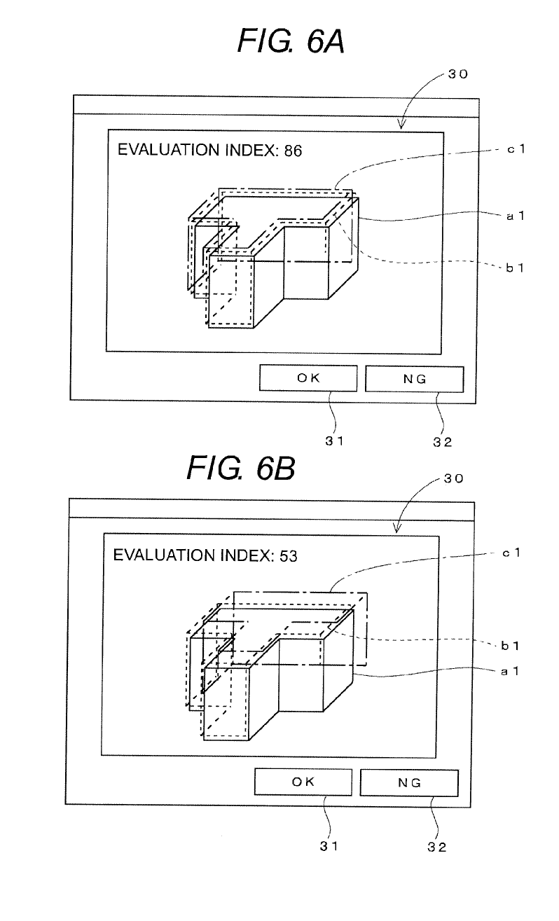

In view of the above aspects, in the present embodiment, the three-dimensional segment in the three-dimensional information to be integrated to the temporary three-dimensional model is combined for every corresponding segments, the difference amount between the three-dimensional segments in the set is obtained for every combination, and an evaluation index representing the accuracy of the temporary three-dimensional model is calculated from each difference amount. After the integration process is terminated, a check screen as shown in FIGS. 6A and 6B is started up to cause the user to judge the accuracy of the temporary three-dimensional model.

The screen shown in FIGS. 6A and 6B includes a window 30 for image display, each operation button 31, 32 (hereinafter referred to as “OK button 31” and “NG button 32”) indicating “OK” and “NG”, and the like. In the window 30, contour patterns a1, b1, c1 (respectively correspond to the three-dimensional information a, b′, c′ shown in FIG. 5) represented by each piece of three-dimensional information integrated to the three-dimensional model are displayed with the above-mentioned evaluation index as an image representing a three-dimensional shape of the temporary three-dimensional model. Each contour pattern a1, b1, c1 may be displayed with different line types, colors, or the like, but all contour patterns may be displayed with the same line type and the same color without distinction.

The user checks the degree of variation of the three-dimensional segment incorporated in an overlapping manner in the temporary three-dimensional model with the image display and the evaluation index, and judges whether or not to actually register the three-dimensional model being displayed.

As shown in FIG. 6A, if the variation between the contour lines representing the same site is small and a relatively high evaluation index is displayed, the user judges that the accuracy of the three-dimensional model is ensured, and operates the OK button 31. When such an operation is performed, the three-dimensional model being displayed is confirmed and actually registered in the memory 25.

As shown in FIG. 6B, if the variation between the contour lines representing the same site is large and the evaluation index is low, the user judges that the information being displayed is inappropriate for the three-dimensional model, and operates the NG button 32. When such an operation is performed, the temporary three-dimensional model being displayed is discarded (temporary registration is canceled).

When the temporary three-dimensional model is discarded, the user resets the measurement environment (adjustment of positional relationship of cameras 11 to 13, three-dimensional calibration, and the like) assuming that accurate three-dimensional measurement is difficult to carry out in the current environment. After the resetting is completed, the stereo measurement of the work model WM is again performed, and a new three-dimensional model is created through alignment and integration process of the restored three-dimensional information and then temporarily registered. The checking task similar to the above is then performed on such a temporary three-dimensional model.

The process of changing the condition and creating the three-dimensional model is repeated until checked that the accuracy of the temporary three-dimensional model is ensured, and the three-dimensional model recognized to have a satisfactory accuracy is actually registered. Thus, the position and the orientation of the work W can be recognized with satisfactory accuracy even in the recognition process (FIG. 3) using the registered three-dimensional model.

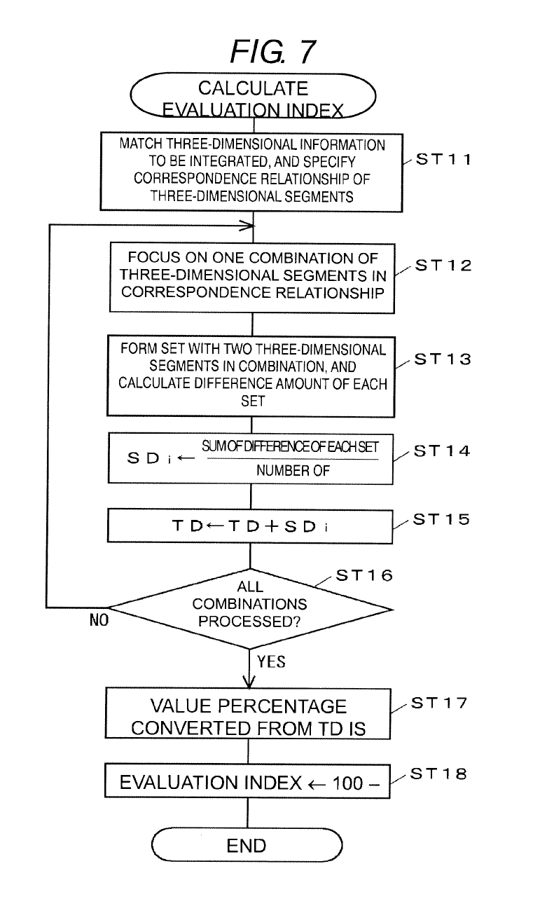

FIG. 7 shows a specific example of a process of calculating the evaluation index as a flowchart.

Describing along the flowchart, the three-dimensional segments of the three-dimensional information to be integrated are first matched to specify the correspondence relationship of the three-dimensional segment among the three-dimensional information in this embodiment (ST11). Specifically, the three-dimensional information are combined by twos, and the segments that exist within a predetermined distance in between and that have a coincidence degree of greater than or equal to a predetermined value are specified as being in a correspondence relationship.

Focusing, in order, on the combination of the three-dimensional segments which corresponding relationship is confirmed between at least two pieces of three-dimensional information (ST12), the three-dimensional segments contained in the set are combined by twos, and the difference amount of each set is calculated (ST13). For example, if the three-dimensional segments A, B, C corresponding to the same feature are contained in the previous three-dimensional information a, b′, respectively, A and B, A and C, and B and C are respectively combined, and the difference amount of each set is calculated. For the difference amount, the distance between the combined segments, the angle difference in the direction indicated by the three-dimensional segments, and the like are calculated.

Thereafter, an average value (obtained by dividing the sum of the difference amount by the number of combinations of the three-dimensional segments) of the difference amount calculated for each set is obtained, which is set as a difference amount SDi in units of segments (ST14). The difference amount SDi is then added to the entire difference amount TD (initial value is zero) (ST15).

Thus, through the execution of the processes ST12 to ST15 for every combination of the three-dimensional segments specified with the correspondence relationship, the difference amount SDi between the segments in the correspondence relationship is individually calculated and the entire difference amount TD is updated for every calculation.

After the process on all the combinations is terminated, the value of the TD at the relevant time point is converted into percentage (ST17). Further, the calculation of subtracting the percentage converted difference amount TD % from 100 is performed, and the result of the calculation is set as the evaluation index (ST18).

The entire evaluation index of the candidates of the three-dimensional model is obtained by integrating the difference amount for every combination of the three-dimensional segments in correspondence relationship, but the present invention is not limited thereto, and the evaluation index may be obtained for every combination of the three-dimensional segments. In this case, the display that allows the relationship of the calculated evaluation index and the three-dimensional segments of the calculation target to be checked is desirably executed in the check screen shown in FIGS. 6A and 6B. For example, a method of, when a mouse cursor is approached to a location where the contour line representing the same site is displayed in plurals, displaying the evaluation index corresponding to the contour patterns near the cursor is considered.

The evaluation index in the above embodiment has a higher value the smaller the variation between the three-dimensional segments, but instead, the difference amount itself may be used and the evaluation index may be set such that the value becomes larger the larger the degree of variation of the three-dimensional segments.

In the above embodiment, the difference amount is calculated for every combination of the three-dimensional segments in the correspondence relationship, but instead, the intersection between the three-dimensional segments in correspondence relationship may be combined, and the difference amount for each combination (distance between intersections and the like) may be calculated.

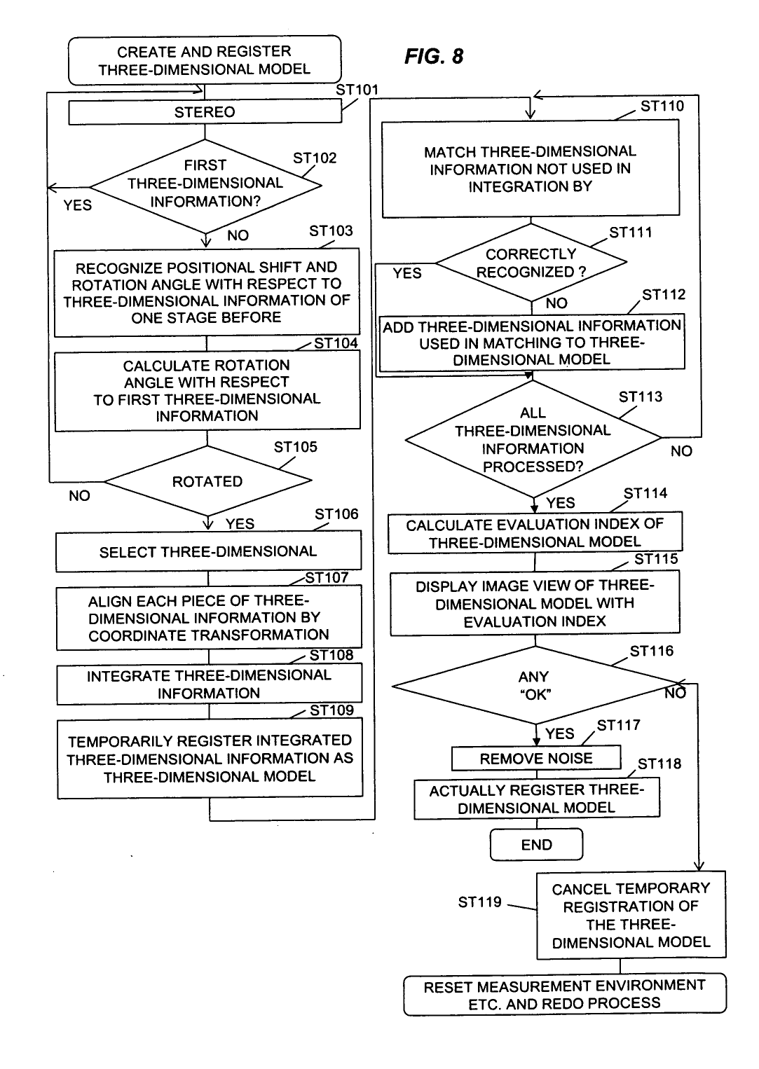

FIG. 8 summarizes a procedure of a process from when the stereo measurement is performed on the work model WM until the three-dimensional model is registered in a flowchart. The procedure for creating the three-dimensional model of the present embodiment will be described below along the flow of the flowchart.

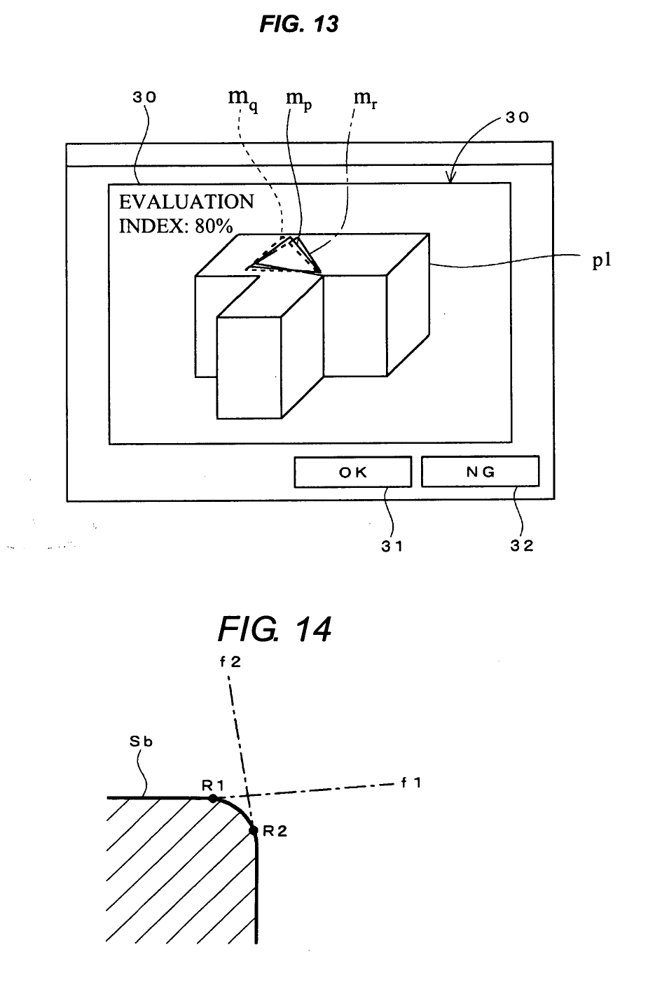

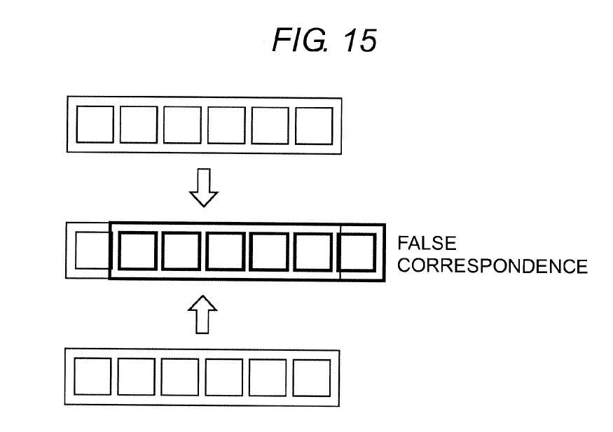

In this embodiment, since the positioning of the work model at the time of measurement is left up to the discretion of the user, a preview image from each camera 11 to 13 is displayed on the display unit 27 during the measurement process. After the user checks whether the work model WM is being correctly imaged by each camera 11 to 13 on the display screen and performs the operation to instruct measurement, the “stereo measurement” step (ST101) in FIG. 13 is executed. In step ST101, the process from the stereo imaging to the restoration of the three-dimensional information (similar to ST1 to ST6 of FIG. 3) is specifically executed.

When the first three-dimensional information is restored by the stereo measurement of first time (“YES” in ST102), the relevant three-dimensional information is saved, and the process returns to ST101 to execute the stereo measurement of second time. If the stereo measurement of the second and subsequent times is performed (“NO” in ST102), the three-dimensional information restored by such measurement is matched with the three-dimensional information of one stage before to recognize the positional shift and the rotation angle with respect to one stage before (ST103). Furthermore, with regards to the rotation angle, the rotation angle with respect to the three-dimensional information restored by the measurement of the first time is calculated (ST104) through a method of adding the recognized value every time.

In the present embodiment, determination is made that the work model WM has rotated once with respect to the stereo camera 1 when the rotation angle with respect to the first three-dimensional information (calculated in ST104) exceeds 360 degrees (ST105). The processes of ST101 to ST105 are repeated until it is determined that the work model WM has rotated once.

When determined that the work model WM has rotated once with respect to the first three-dimensional information, the loop of ST101 to ST105 is terminated, and the three-dimensional information to be integrated are selected (ST106). For example, the three-dimensional information to be integrated are selected such that the direction of the work model WM represented by the rotation angle differs by greater than or equal to a constant angle based on the rotation angle obtained in ST103. The image representing the contour pattern of the restored three-dimensional information may be displayed in order on the display unit 27, and the selection by the user may be accepted.

After the three-dimensional information to be integrated are selected, using one piece of the three-dimensional information as a reference, other pieces of three-dimensional information are aligned to the reference three-dimensional information (ST107), and each piece of three-dimensional information after the alignment are integrated (ST108). Integrated three-dimensional information is temporarily registered as a three-dimensional model (ST109).

The next loop of ST110 to ST113 aims to enhance the accuracy of the three-dimensional model. Even if the three-dimensional model is created by selecting the integrating targets of the three-dimensional information while taking into consideration not to be biased to those by the measurement of a specific range, the orientation of the work model WM may be only slightly changed and the recognition by the integrated three-dimensional information may not be possible depending on the shape of the work model WM. Taking such an aspect into consideration, in ST110 to ST113, with the three-dimensional information excluded from the integration as the target in order, whether such three-dimensional information can be correctly recognized by the integrated information is determined, and the three-dimensional information determined that an error occurred in the recognition is added to the three-dimensional model.

In this loop, the matching by the temporarily registered three-dimensional model is first performed with the three-dimensional information not selected as the integrating target as the target in order, and the positional shift amount and the rotation angle with respect to the three-dimensional model are calculated (ST110). The calculation values are then compared with the values derived from the positional shift amount and the rotation angle obtained for every measurement point to determine whether or not correct recognition is performed (ST111).

If determined that the three-dimensional information of the matching target is not correctly recognized (“NO” in ST111), the three-dimensional information used in the matching is aligned with the three-dimensional model and added to the three-dimensional model (ST112). If the three-dimensional information of the matching target is correctly recognized (“YES” in ST111), such three-dimensional information is not added to the three-dimensional model, and the process proceeds to the next step. Even in the alignment of when adding new three-dimensional information to the three-dimensional model, the coordinate transformation process based on the positional shift amount and the rotation angle obtained for every measurement point is executed.

According to the above process, similar false recognition no longer occurs with the subsequent three-dimensional model and the accuracy of the three-dimensional model can be enhanced since the temporarily registered three-dimensional model is added with the three-dimensional information not recognized in such a model. Furthermore, the capacity of the three-dimensional model is prevented from increasing since the correctly recognized three-dimensional information is not added to the three-dimensional model.

After the three-dimensional information to be contained in the three-dimensional model are defined through the processes up to ST113, the process of calculating the evaluation index of the three-dimensional model is executed (ST114). Specifically, the procedure described with FIG. 7 is executed to calculate the evaluation index with the three-dimensional information selected as the integrating target to the three-dimensional model and the three-dimensional information added to the relevant three-dimensional model after the temporary registration of the three-dimensional model as the target. Furthermore, the check screen shown in FIGS. 6A and 6B is started, and the image view of the three-dimensional model as well as the calculated evaluation index are displayed on the screen (ST115).

When the OK button 31 is operated with respect to such display (“YES” in ST116), the process (ST117) of removing the noise from the temporary three-dimensional model is executed, the three-dimensional model after removed with the noise is actually registered (ST118), and the process is terminated.

In the noise removing process of ST117, the three-dimensional segment which length is smaller than or equal to a predetermined threshold value, and the three-dimensional segment which number of sampling points of the three-dimensional coordinate is smaller than or equal to a predetermined number in the three-dimensional segments configuring the three-dimensional model are deleted. The three-dimensional segment corresponding to the shade is detected from the distribution state of the three-dimensional coordinate of the XZ plane, and deleted. The false correspondence in the matching process is thus prevented by deleting the short three-dimensional segment, the three-dimensional segment with few number of sampling points, the three-dimensional segment representing shade, and the like. Since the capacity of the three-dimensional model is reduced, the time of the checking process can be reduced.

When the NG button 32 is operated with respect to the image view of the three-dimensional model and the display of the evaluation index (“NO” in ST116), the temporary registration of the three-dimensional model is canceled (ST119). In this case, the procedure of FIG. 8 is again performed from the beginning after the measurement environment and the like are reset.

According to the above embodiment, the accuracy of the positional shift amount and the rotation angle calculated for every second and subsequent measurements can be ensured by performing the measurement while changing the relationship of the work model WM and the stereo camera 1 little by little, so that the accuracy of alignment of the three-dimensional information to be integrated to the three-dimensional model can be ensured. Even if an element that may cause false correspondence exists in the contour line of the three-dimensional model and the accuracy of alignment of each three-dimensional information lowers thereby, the element can be easily checked from the image view of the three-dimensional model and the display of the evaluation index, whereby the three-dimensional model of unsatisfactory accuracy is prevented from being registered.

An option of correcting one part and registering may be provided in addition to the option of registering the created three-dimensional model as is and the option of discarding without registering. For example, if a large difference amount appears only in a specific combination of the combinations of the three-dimensional segments in correspondence relationship, and the difference amount related to other combinations is within the tolerable range, each three-dimensional segment belonging to the combination where large difference amount is produced is deleted and the remaining information may be actually registered as the three-dimensional model. This is based on the assumption that troubles do not arise in the recognition of the work W by the deletion of the three-dimensional segment.

### 3-2) Second Embodiment

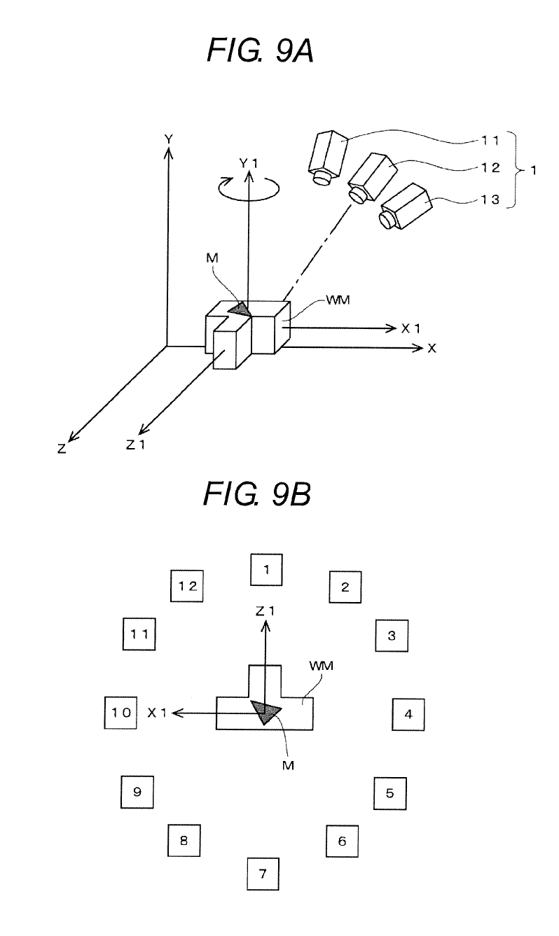

In the second embodiment, the stereo measurement is executed with a triangular mark M attached to an appropriate location of the work model WM, as shown in FIGS. 9A and 9B in an aim of enhancing the accuracy of alignment between the three-dimensional information to be integrated to the three-dimensional model and enabling the accuracy of the created three-dimensional model to be more easily checked. The mark M is configured as a sticker, and is attached to a flat surface of the work model WM. The mark M has a size set to be smaller than the surface to which it is attached, and is colored with a color with which the contrast with the color of the base of the work model WM becomes clear.

In this embodiment as well, the three-dimensional model is created by rotating the work model WM at an arbitrary angle with the hand of the user to set a plurality of measurement points, and integrating a predetermined number (two or more) of three-dimensional information restored at each measurement point, similar to the first embodiment. However, the measurement point of the second embodiment defines achieving a state in which the mark M is included in the view of all cameras 11 to 13 as a condition. In the second embodiment, the mark M is attached to the surface that becomes the upper surface in the measurement of the work model WM to facilitate the setting.

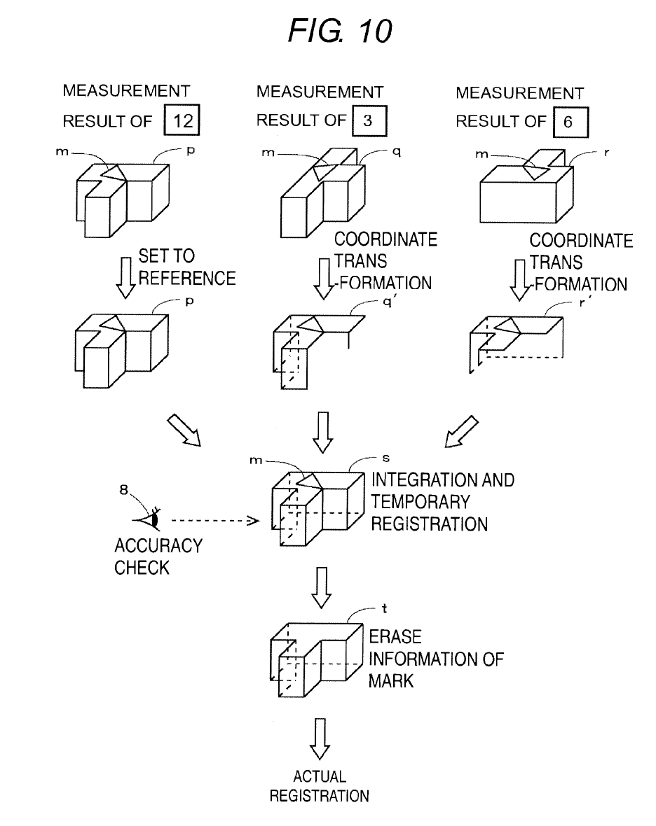

FIG. 10 shows a schematic procedure of the process of creating the three-dimensional model using the work model WM attached with the model M. In this figure as well, the three-dimensional information restored at the measurement points [12], [3], [6] are used, similar to FIG. 5. Since the above three-dimensional information contains information m representing the mark M, each piece of three-dimensional information is indicated with reference numerals p, q, r different from FIG. 5.

In this embodiment as well, with the three-dimensional information p of the measurement point [12] as the reference, the other three-dimensional information q, r are coordinate transformed to align with the three-dimensional information p. Similar to the previous embodiment, the positional shift amount and the rotation angle obtained by matching with the three-dimensional information of one stage before for every measurement point are used in the coordinate transformation.

After the coordinate transformation, three-dimensional information s containing the features of the respective information is created by integrating the three-dimensional information q′, r′ after the transformation and the reference three-dimensional information p. The three-dimensional information s is then temporarily registered as the three-dimensional model, and the accuracy of the temporarily registered three-dimensional model s is checked with the eye 8 of the user. After the user checks that the accuracy of the three-dimensional model s is ensured and makes determination to actually register, the information m of the mark M is erased from the temporarily registered three-dimensional model s, and three-dimensional information t after the process is actually registered as the three-dimensional model.

The temporary three-dimensional model s created by the integration process contains all pieces of the three-dimensional information p, q′, r′ before the integration. Therefore, with respect to the mark M, three pieces of information transferred from each piece of three-dimensional information p, q′, r′ are actually contained in the temporary three-dimensional model s.

The properties and functions of the mark M will be described below.

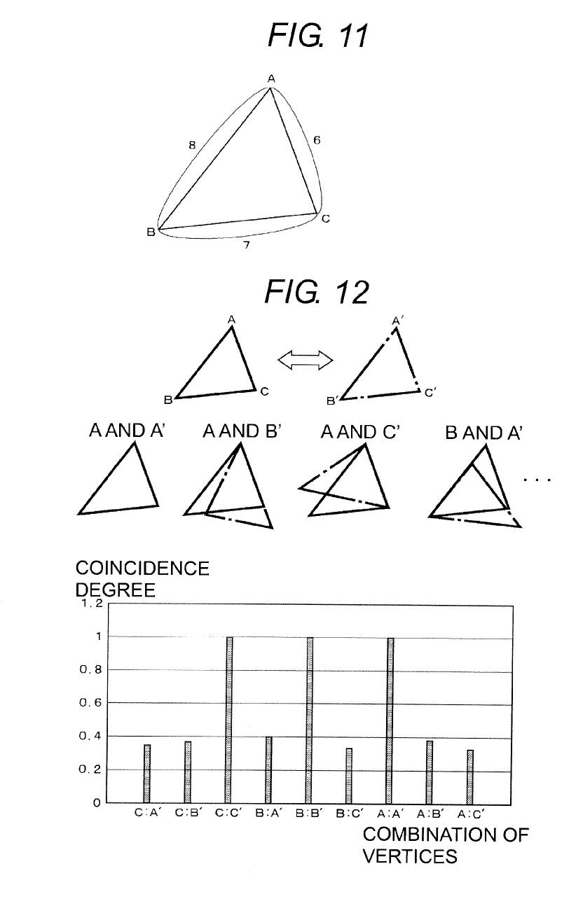

As shown in FIG. 11, the triangle representing the mark M used in the present embodiment is set such that the ratio of each side is 6:7:8. According to such ratio, each vertex A, B, C of the mark M can be easily specified, and thus the direction of the mark M can be uniquely specified by the direction of a perpendicular line from the vertex A to the side BC, and the like. Furthermore, as shown in FIGS. 12A and 12B, the accuracy of alignment can be ensured when aligning with the triangle A′B′C′ of the same shape.

In FIG. 12A, the results of selecting a vertex one at a time from the triangle ABC having the above ratio and the triangle A′B′C′ congruent thereto, and aligning each triangle with the selected vertex as a reference are shown. As shown in the figure, each triangle do not completely overlap unless the vertices in correct correspondence relationship are combined.

In the correspondence of the triangles, the inventors actually obtained the coincidence degree of the entire triangle for every combination of vertices. FIG. 12B is a graph showing the results thereof. As shown in the graph, assuming the coincidence degree of when each vertex is correctly corresponded is one, the coincidence degree by other correspondence relationships becomes about 0.4 at a maximum. It was recognized that the right and wrong of the correspondence relationship of the triangle can be correctly determined thereby.

As described above, according to the triangle having the shape shown in FIG. 11, a large difference is created in the coincidence degree for when each vertex of the triangle is correctly corresponded and when error is found in the correspondence. Since similar effects are to be obtained when performing correspondence with each side of the triangle as the three-dimensional segment, the coincidence degree related to the three-dimensional segment of each side of the triangle greatly influences the overall coincidence degree when the entire three-dimensional information containing the three-dimensional segment of the mark M are matched.

In other words, even if an element that causes misalignment exists in the original three-dimensional segment of the work model WM, if false correspondence is performed, the coincidence degree of the entire three-dimensional information lowers as the coincidence degree of the three-dimensional segment of the triangle greatly lowers. If each three-dimensional segment containing the three-dimensional segment of the triangle is correctly aligned, the coincidence degree becomes high in all three-dimensional segments, and thus the coincidence degree of the entire three-dimensional information also takes a high value. Thus, the coincidence degree of when correctly corresponded is made greater than other cases, and the accuracy of alignment can be ensured.

The shape of the triangle indicated by the mark M is not limited to the example of FIG. 11, and the ratio of the sides may be arbitrary as long as the above-described effects can be obtained. In addition, the shape is not limited to a triangle, and a mark having a polygonal shape with four or more vertices and which direction can be uniquely specified may also be created.

The mark M is also used in the process of checking the accuracy of the temporarily registered three-dimensional model. For this process, the three-dimensional model data representing the geometric information of the mark M, specifically, combination of data representing the preferred three-dimensional segments of the three sides of the triangle (the model data is hereinafter referred to as “model triangle”) are registered in the memory 25 of the device of the present embodiment.

In the present embodiment, each piece of the three-dimensional information integrated in the three-dimensional model is respectively matched by the model triangle, and the three-dimensional segment with respect to the model triangle, that is, the three-dimensional segment representing each side of the mark M is specified. The three-dimensional segment specified from each piece of the three-dimensional information is then combined for every three-dimensional segments in correspondence relationship to calculate the difference amount. The difference amount of each set is further integrated to calculate the evaluation index.

The calculation of the difference amount and the evaluation index can be implemented through the method complying with the example of FIG. 7. In this embodiment as well, in place of the difference amount between the three-dimensional segments, the intersection (Le., vertex of triangle) between the three-dimensional segments may be combined for every corresponding ones and the distance between the vertices may be obtained as the difference for every combination.

In the second embodiment, the measurement is performed with the mark M included in the view of each camera 11, 12, 13 at all measurement points, and thus the three-dimensional information integrated in the three-dimensional model always contains the information m corresponding to the mark M. Therefore, through the matching process based on the known geometric information of the mark M, the three-dimensional segments in correspondence relationship are easily specified between the three-dimensional information, and the evaluation index is obtained, whereby the process can be simplified. Since the calculated evaluation index reflects the degree of variation of the information m commonly contained in all pieces of the three-dimensional information that are integrated, the accuracy of alignment between the integrated three-dimensional information can be easily checked by the evaluation index.

Therefore, the accuracy of alignment of the three-dimensional information to be integrated can be enhanced and the accuracy of the created three-dimensional model can be easily checked by attaching the mark M, which direction can be uniquely specified and which three-dimensional shape is registered, to the work model WM and restoring the three-dimensional information containing the contour pattern of the mark M.

To obtain the above effects, the mark M is desirably attached to a flat surface of the work model WM. If the mark M is attached to a curved surface, the possibility that each side of the triangle is recognized as the three-dimensional segment of a curve becomes high, and the restored shape of the mark fluctuates by the curvature of the curved surface. Thus, if the mark M is attached to the curved surface, the possibility that the original shape of the triangle is not restored becomes high even if the three-dimensional information is correctly restored, and the accuracy of matching with the model triangle also lowers.

FIG. 13 shows an example of a check screen using the mark M. The window 30, the OK button 31, and the NG button 32, similar to the example of FIGS. 6A and 6B, are arranged in the screen. The display also corresponds to the temporary three-dimensional model s created in the example of FIG. 10.

Not all pieces of information contained in the temporary three-dimensional model, but only the contour pattern p1 based on the reference three-dimensional information p is displayed in the window 30. With regards to the mark M, the contour patterns mₚ, m_{q}, mᵣ corresponding to all pieces of the information of the mark M extracted from each piece of the three-dimensional information p, q′, r′ through matching with the model triangle are displayed. Furthermore, in the window 30, the evaluation index calculated from the difference amount between the three-dimensional segments corresponding to the mark M is displayed.

The user checks the accuracy of the temporary three-dimensional model from the overlapping degree of the contour patterns mₚ, m_{q}, mᵣ of the triangle and the value of the evaluation index on the screen described above. When the user determines to actually register the three-dimensional model and operates the OK button 31, the information corresponding to the mark M is erased from the temporary three-dimensional model s, and the three-dimensional information t after erasure is actually registered as the three-dimensional model. The information of the mark M does not necessarily need to be erased, and the information may just be invalidated.

### 3-3) Other Embodiments

In both of the first and second embodiments described above, the user checks the accuracy of the temporary three-dimensional model after the temporary three-dimensional model is created by aligning and integrating a predetermined number of three-dimensional information, but instead, the evaluation index may be calculated before the process of integrating the three-dimensional information and the value of the evaluation index may be displayed. In this case, when the users checks the accuracy of the integrated information by the displayed evaluation index and makes a determination input to adopt the integrated information as the three-dimensional model, the integration process of the three-dimensional information is performed and the generated three-dimensional information is registered as the three-dimensional model.

In the above process, the mark M of the second embodiment is attached to the work model WM, and the information corresponding to the mark M is desirably excluded from the target of integration when the evaluation index based on the mark M is obtained.

In each embodiment, the screen for checking the accuracy of the three-dimensional model is displayed on the display unit 27 of the own device, but the present invention is not limited thereto. The evaluation index and the image data may be outputted to an external device, the checking task may be carried out at the external device side, and the determination inputted from the external device may be accepted.

1. A method of creating a three-dimensional model of a target object to be recognized by executing a process of restoring three-dimensional information of a contour line through three-dimensional measurement using a stereo camera with respect to an actual model of the target object to be recognized while arbitrarily changing a positional relationship between the actual model and the stereo camera every time, aligning the three-dimensional information restored by the measurement of a plurality of times, and integrating each piece of the three-dimensional information after the alignment; wherein the steps of:
extracting information in an overlapped relationship by matching a plurality of pieces of three-dimensional information to be integrated with each other and calculating a difference amount between contour patterns represented by the extracted information,
determining an evaluation value representing accuracy of integrated information including the plurality of pieces of three-dimensional information based on the difference amount, and
outputting the determined evaluation value, are executed before integrating or after integrating the plurality of pieces of three-dimensional information.

2. The method of creating a three-dimensional model according to claim 1, further comprising the steps of:
accepting a determination input on whether or not to adopt the integrated information corresponding to the evaluation value as the three-dimensional model after the output of the evaluation value; and
confirming the integrated information as the three-dimensional model in response to accepting the determination input to adopt the integrated information as the three-dimensional model.

3. The method of creating a three-dimensional model according to claim 1, wherein
a step of generating an image reflecting all contour patterns by each piece of three-dimensional information after the alignment is executed at least before the step of outputting the evaluation value, the step of outputting the evaluation value including displaying the evaluation value along with the image.

4. The method of creating a three-dimensional model according to claim 1, wherein
in the three-dimensional measurement of every time on the actual model, the three-dimensional information having a configuration in which a three-dimensional coordinate representing a contour line is grouped to a plurality of three-dimensional segments is generated; and
in the step of calculating the difference amount, the difference amount related to the combination is calculated for every combination of the three-dimensional segments in correspondence relationship between the three-dimensional information before integration.

5. The method of creating a three-dimensional model according to claim 1, wherein
in the three-dimensional measurement of every time on the actual model, the three-dimensional information having a configuration in which a three-dimensional coordinate representing a contour line is grouped to a plurality of three-dimensional segments is generated; and
in the step of calculating the difference amount, an intersection between each three-dimensional segment is combined for every correspondence between the three-dimensional information before integration, and the difference amount related to the combination is calculated for every combination.

6. The method of creating a three-dimensional model according to claim 1, wherein
in three-dimensional measurement of every time, with an actual model attached with a mark having a known geometric feature on the surface as a target, the positional relationship between the actual model and each camera is adjusted so that the mark is contained in fields of all cameras configuring the stereo camera; and
in the step of calculating the difference amount, each piece of the three-dimensional information to be integrated is matched by a contour pattern of the mark based on the known geometric feature to extract the contour pattern of the mark, and the difference amount between the contour patterns extracted from each piece of the three-dimensional information is calculated.

7. An object recognizing device comprising a three-dimensional measurement unit for restoring three-dimensional information of a contour line of a target object to be recognized through three-dimensional measurement using a stereo camera, a recognition processing unit for recognizing a position and an orientation of the target object to be recognized by matching the restored three-dimensional information with a three-dimensional model registered in advance, a three-dimensional model creating unit for aligning a plurality of pieces of three-dimensional information restored through the three-dimensional measurement executed by the three-dimensional measurement unit from different directions on an actual model of the target object to be recognized and creating a three-dimensional model to be used by the recognition processing unit by integrating each piece of the three-dimensional information after the alignment, and a three-dimensional model registering unit for registering the created three-dimensional model; wherein
the three-dimensional model creating unit includes,
a difference amount calculating portion for extracting information in an overlapped relationship in each piece of the three-dimensional information by matching a plurality of pieces of three-dimensional information to be integrated with each other and calculating a difference amount between contour patterns represented by the extracted information,
an evaluation value determining portion for determining an evaluation value representing accuracy of the integrated information including the plurality of pieces of three-dimensional information based on the difference amount calculated by the difference amount calculating portion, and
an output portion for outputting the evaluation value determined by the evaluation value determining portion.

8. The object recognizing device according to claim 7, wherein the three-dimensional model creating unit further includes,
an input portion for accepting a determination input on whether or not to adopt the integrated information corresponding to the evaluation value as the three-dimensional model after the output of the evaluation value, and
a model confirming portion for confirming the integrated information as the three-dimensional model when the input portion accepts the determination input to adopt the integrated information as the three-dimensional model.

9. The object recognizing device according to claim 7, wherein
the three-dimensional model creating unit further includes an image generating portion for generating an image reflecting all contour patterns by each piece of the three-dimensional information after the alignment; and
the output portion is configured as a portion for displaying the evaluation value along with the image generated by the image generating portion.

10. The object recognizing device according to claim 7, further comprising:
a registering unit for registering a contour pattern based on a geometric feature for a mark created on a premise of being attached to a surface of the actual model; wherein
the difference amount calculating portion extracts the contour pattern of the mark by matching the three-dimensional information to be integrated by the contour pattern registered in the registering unit, and calculates the difference amount between the contour patterns extracted from each piece of the three-dimensional information.
